(19) United States
(12) Patent Application Publication
(10) Pub. No.: US 2024/0200962 A1
(43) Pub. Date: Jun. 20, 2024

(54) PROVIDING DIRECTIONAL AWARENESS INDICATORS BASED ON CONTEXT

(71) Applicant: APPLE INC., Cupertino, CA (US)

(72) Inventors: Brian W. TEMPLE, Santa Clara, CA (US); Devin W. CHALMERS, Oakland, CA (US); Thomas G. SALTER, San Francisco, CA (US); Yiqiang NIE, San Francisco, CA (US)

(21) Appl. No.: 18/594,032

(22) Filed: Mar. 4, 2024

Related U.S. Application Data
(63) Continuation of application No. PCT/US2022/042683, filed on Sep. 7, 2022.
(60) Provisional application No. 63/246,083, filed on Sep. 20, 2021.

(51) Int. Cl. G01C 21/36; G02B 27/01; G06F 3/01; G06F 3/0346; G06F 3/16; G06T 19/00; H04M 1/72454; H04W 4/024

(52) U.S. Cl. CPC G01C 21/3632; G02B 27/017; G06F 3/012; G06F 3/013; G06F 3/0346; G06F 3/167; G06T 19/006; H04M 1/72454; H04W 4/024; G02B 2027/0138

(57) ABSTRACT

Various implementations disclosed herein include devices, systems, and methods that provides directional awareness indicators based on context detected in a physical environment. For example, an example process may include obtaining sensor data from one or more sensors of the device in a physical environment, detecting a context associated with a use of the device in the physical environment based on the sensor data, determining whether to present a directional awareness indicator based on determining that the context represents a state in which the user would benefit from the directional awareness indicator, and in accordance with determining to present the directional awareness indicator, identifying a direction for the directional awareness indicator, wherein the direction corresponds to a cardinal direction or a direction towards an anchored location or an anchored device, and presenting the directional awareness indicator based on the identified direction.

### CROSS-REFERENCE TO RELATED APPLICATIONS

This application is a continuation of International Application No. PCT/US2022/042683 (International Publication No. WO2023/043646) filed on Sep. 7, 2022, which claims priority to U.S. Provisional Application No. 63/246,083 filed on Sep. 20, 2021, both entitled “PROVIDING DIRECTIONAL AWARENESS INDICATORS BASED ON CONTEXT,” each of which is incorporated herein by this reference in its entirety.

### TECHNICAL FIELD

The present disclosure generally relates to displaying content with electronic devices and, in particular, to systems, methods, and devices that determine and present a directional awareness indicator based on context of a real-world physical environment.

### BACKGROUND

Electronic devices are often used to present users with virtual objects, such as application content, that complement surrounding physical environments that are perceivable in views provided by such electronic devices. Some existing techniques provide views of three-dimensional (3D) environments that may be difficult to navigate. For example, a user may view the physical environment with additional virtual content while walking around the physical environment and lose his or her sense of direction. Thus, it may be desirable to provide a means of efficiently providing direction or an indication for orienting a user in a 3D environment.

### SUMMARY

Various implementations disclosed herein include devices, systems, and methods that provide directional awareness indicators (e.g., subtle visual/audio, non-intrusive cues) in certain detected contexts to supplement a user's natural sense of direction. In one example, a ping is played from the north every five minutes using spatial audio. Example contexts that may trigger such indicators include a user (a) being in a new city or unfamiliar location, (b) performing an activity such as hiking for which orientation is important, (c) acting disoriented or lost, and/or (d) being proximate to a particular location, object, or person. A directional awareness indicator may identify a cardinal direction (e.g., north) or a direction towards an anchored location or device (e.g., a camp site or another user's device (shared with permission) at a rock concert). The directional awareness indicators may change visually or audibly, for example, based on the factors such as proximity to a particular location, object, or person.

In some implementations, directional awareness indicators may be provided in one or more different sets of views to improve a user experience (e.g., while wearing a head mounted display (HMD) for pass through video). Some implementations allow interactions with the directional awareness indicators (e.g., an application widget). In some implementations, a device (e.g., a handheld, laptop, desktop, or HMD) provides views of a three-dimensional (3D) environment (e.g., a visual and/or auditory experience) to the user and obtains, with a sensor, physiological data (e.g., gaze characteristics) and motion data (e.g., controller moving the avatar, head movements, etc.) associated with a response of the user. Based on the obtained physiological data, the techniques described herein can determine a user's vestibular cues during the viewing of a 3D environment (e.g., an extended reality (XR) environment) by tracking the user's gaze characteristic(s) and other interactions (e.g., user movements in the physical environment). Based on the vestibular cues, the techniques can detect interactions with the directional awareness indicators and provide a different set of views to improve a user's experience while viewing the 3D environment. For example, a user's experience may be changed based on detecting that the user is in a situation in which the user would benefit from direction awareness assistance, the user has started moving towards an expected target location (from a calendar app), the user has stopped moving at an intersection as if uncertain (e.g., is acting lost, such as turning around)>920°, and/or the user is within a proximity threshold of another user's device or a particular location.

In general, one innovative aspect of the subject matter described in this specification can be embodied in methods, at an electronic device having a processor and one or more sensors, that include the actions of obtaining sensor data from one or more sensors of the device in a physical environment, detecting a context associated with a use of the device based on the sensor data and historical use of the electronic device in the physical environment, determining whether to present a directional awareness indicator based on the context associated with the use of the electronic device in the physical environment, and in accordance with determining to present the directional awareness indicator, identifying a direction for the directional awareness indicator, wherein the direction corresponds to a cardinal direction or a direction towards an anchored location or an anchored device, and presenting the directional awareness indicator based on the identified direction.

These and other embodiments can each optionally include one or more of the following features.

In some aspects, presenting the directional awareness indicator is further based on a three-dimensional (3D) position relative to the electronic device. In some aspects, the directional awareness indicator comprises an audio cue played to be heard from the 3D position using spatial audio, wherein the 3D position is determined based on the identified direction.

In some aspects, the directional awareness indicator is a visual cue positioned to appear at the 3D position in a view of the physical environment provided via the electronic device, wherein the 3D position is determined based on the identified direction. In some aspects, the directional awareness indicator is not presented based on a criterion with respect to the detected context associated with the use of the electronic device in the physical environment.

In some aspects, the directional awareness indicator is presented intermittently. In some aspects, presenting the directional awareness indicator intermittently is based on movement of the electronic device. In some aspects, presenting the directional awareness indicator intermittently is based on historical use of the directional awareness indicator with respect to the 3D position.

In some aspects, the method further includes, in accordance with detecting a request to stop presenting the directional awareness indicator, ceasing to present the directional awareness indicator. In some aspects, the method further includes, modifying the directional awareness indicator over time based on proximity of the electronic device to the anchored location or device.

In some aspects, detecting the context includes determining use of the electronic device in a new location. In some aspects, detecting the context includes determining use of the electronic device during a type of activity. In some aspects, detecting the context includes determining that a user of the electronic device is disoriented or lost. In some aspects, detecting the context includes determining that the electronic device is within a proximity threshold distance of a location, an object, another electronic device, or a person.

In some aspects, the electronic device is a head-mounted device (HMD).

In accordance with some implementations, a non-transitory computer readable storage medium has stored therein instructions that are computer-executable to perform or cause performance of any of the methods described herein. In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a device presenting a visual environment and obtaining physiological data from a user according to some implementations.

FIG. 2A illustrates an example location map of a user with an electronic device in a physical environment in accordance with some implementations.

FIG. 2B illustrates an exemplary view of the electronic device for the user of FIG. 2A that includes a directional awareness indicator in accordance with some implementations.

FIG. 3A illustrates an example location map based on the movement of a user with an electronic device in an urban setting in accordance with some implementations.

FIG. 3B illustrates an exemplary view of the electronic device for the user of FIG. 3A that includes a directional awareness indicator in accordance with some implementations.

FIG. 4 is a flowchart representation of providing a directional awareness indicator based on context detected in a physical environment in accordance with some implementations.

FIG. 5 illustrates device components of an exemplary device according to some implementations.

FIG. 6 illustrates an example head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects or variants do not include all of the specific details described herein. Moreover, well-known systems, methods, components, devices and circuits have not been described in exhaustive detail so as not to obscure more pertinent aspects of the example implementations described herein.

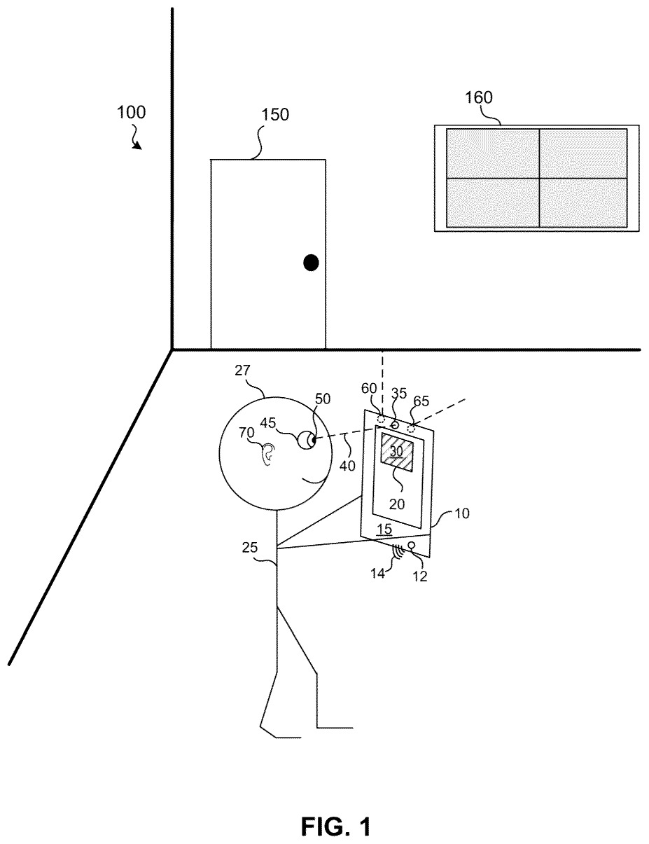

FIG. 1 illustrates a real-world physical environment 100 including a device 10 with a display 15. In some implementations, the device 10 presents content 20 to a user 25, and a visual characteristic 30 that is associated with content 20. The physical environment 100 includes a door 150 and a window 160. For example, content 20 may be a button, a user interface icon, a text box, a graphic, etc. In some implementations, the visual characteristic 30 associated with content 20 includes visual characteristics such as hue, saturation, size, shape, spatial frequency, motion, highlighting, etc. For example, content 20 may be displayed with a visual characteristic 30 of green highlighting covering or surrounding content 20.

In some implementations, content 20 may represent a visual 3D environment (e.g., an extended reality (XR) environment), and the visual characteristic 30 of the 3D environment may continuously change. In some implementations, content 20 representing a visual 3D environment may be presented using images/video of the environment captured by sensors 60, 65 and shown using a display of device 15. In other implementations, content 20 representing a visual 3D environment may be presented by providing a view of the environment seen through a transparent or translucent display of device 15. Head pose measurements may be obtained by an inertial measurement unit (IMU) or other tracking systems. In one example, a user can perceive a real-world physical environment while holding, wearing, or being proximate to an electronic device that includes one or more sensors that obtains physiological data to assess an eye characteristic that is indicative of the user's gaze characteristics, and motion data of a user.

In some implementations, the visual characteristic 30 is a feedback mechanism for the user that is specific to the views of the 3D environment (e.g., a visual or audio cue presented during the viewing). In some implementations, the view of the 3D environment (e.g., content 20) can occupy the entire display area of display 15. For example, content 20 may include a sequence of images as the visual characteristic 30 and/or audio cues presented to the user (e.g., 360-degree video on a head mounted device (HMD)).

The device 10 obtains physiological data (e.g., pupillary data) from the user 25 via a sensor 35 (e.g., one or more camera's facing the user to capture light intensity data and/or depth data of a user's facial features and/or eye gaze). For example, the device 10 obtains eye gaze characteristic data 40. While this example and other examples discussed herein illustrate a single device 10 in a real-world physical environment 100, the techniques disclosed herein are applicable to multiple devices as well as to other real-world physical environments. For example, the functions of device 10 may be performed by multiple devices.

In some implementations, as illustrated in FIG. 1, the device 10 is a handheld electronic device (e.g., a smartphone or a tablet). In some implementations, the device 10 is a wearable HMD. In some implementations the device 10 is a laptop computer or a desktop computer. In some implementations, the device 10 has a touchpad and, in some implementations, the device 10 has a touch-sensitive display (also known as a “touch screen” or “touch screen display”).

In some implementations, the device 10 includes sensors 60, 65 for acquiring image data of the physical environment. The image data can include light intensity image data and/or depth data. For example, sensor 60 may be a video camera for capturing RGB data, and sensor 65 may be a depth sensor (e.g., a structured light, a time-of-flight, or the like) for capturing depth data.

In some implementations, the device 10 includes an eye tracking system for detecting eye position and eye movements. For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user 25. Moreover, the illumination source of the device 10 may emit NIR light to illuminate the eyes of the user 25 and the NIR camera may capture images of the eyes of the user 25. In some implementations, images captured by the eye tracking system may be analyzed to detect position and movements of the eyes of the user 25, or to detect other information about the eyes such as pupil dilation or pupil diameter. Moreover, the point of gaze estimated from the eye tracking images may enable gaze-based interaction with content shown on the display of the device 10.

In some implementations, the device 10 has a graphical user interface (GUI), one or more processors, memory and one or more modules, programs or sets of instructions stored in the memory for performing multiple functions. In some implementations, the user 25 interacts with the GUI through finger contacts and gestures on the touch-sensitive surface. In some implementations, the functions include image editing, drawing, presenting, word processing, website creating, disk authoring, spreadsheet making, game playing, telephoning, video conferencing, e-mailing, instant messaging, workout support, digital photographing, digital videoing, web browsing, digital music playing, and/or digital video playing. Executable instructions for performing these functions may be included in a computer readable storage medium or other computer program product configured for execution by one or more processors.

In some implementations, the device 10 employs various physiological sensor, detection, or measurement systems. In an exemplary implementation, detected physiological data includes head pose measurements determined by an IMU or other tracking system. In some implementations, detected physiological data may include, but is not limited to, electroencephalography (EEG), electrocardiogramactromyography (EMG), functional near infrared spectroscopy signal (fNIRS), blood pressure, skin conductance, or pupillary response. Moreover, the device 10 may concurrently detect multiple forms of physiological data in order to benefit from synchronous acquisition of physiological data. Moreover, in some implementations, the physiological data represents involuntary data, e.g., responses that are not under conscious control. For example, a pupillary response may represent an involuntary movement.

In some implementations, a machine learning model (e.g., a trained neural network) is applied to identify patterns in physiological data, including identification of physiological responses to viewing the 3D environment (e.g., content 20 of FIG. 1). Moreover, the machine learning model may be used to match the patterns with learned patterns corresponding to indications of interest or intent of the user 25 interactions. In some implementations, the techniques described herein may learn patterns specific to the particular user 25. For example, the techniques may learn from determining that a peak pattern represents an indication of interest or intent of the user 25 in response to a particular visual characteristic 30 when viewing the 3D environment, and use this information to subsequently identify a similar peak pattern as another indication of interest or intent of the user 25. Such learning can take into account the user's relative interactions with multiple visual characteristics 30, in order to further adjust the visual characteristic 30 and enhance the user's physiological response to the 3D environment.

In some implementations, the location and features of the head 27 of the user 25 (e.g., an edge of the eye, a nose or a nostril) are extracted by the device 10 and used in finding coarse location coordinates of the eyes 45 of the user 25, thus simplifying the determination of precise eye 45 features (e.g., position, gaze direction, etc.) and making the gaze characteristic(s) measurement more reliable and robust. Furthermore, the device 10 may readily combine the 3D location of parts of the head 27 with gaze angle information obtained via eye part image analysis in order to identify a given on-screen object at which the user 25 is looking at any given time. In some implementations, the use of 3D mapping in conjunction with gaze tracking allows the user 25 to move his or her head 27 and eyes 45 freely while reducing or eliminating the need to actively track the head 27 using sensors or emitters on the head 27.

By tracking the eyes 45, some implementations reduce the need to re-calibrate the user 25 after the user 25 moves his or her head 27. In some implementations, the device 10 uses depth information to track the pupil's 50 movement, thereby enabling a reliable present pupil diameter to be calculated based on a single calibration of user 25. Utilizing techniques such as pupil-center-corneal reflection (PCCR), pupil tracking, and pupil shape, the device 10 may calculate the pupil diameter 55, as well as a gaze angle of the eye 45 from a fixed point of the head 27, and use the location information of the head 27 in order to re-calculate the gaze angle and other gaze characteristic(s) measurements. In addition to reduced recalibrations, further benefits of tracking the head 27 may include reducing the number of light projecting sources and reducing the number of cameras used to track the eye 45.

In some implementations, a pupillary response may be in response to an auditory stimulus that one or both ears 70 of the user 25 detect. For example, device 10 may include a speaker 12 that projects sound via sound waves 14. The device 10 may include other audio sources such as a headphone jack for headphones, a wireless connection to an external speaker, and the like.

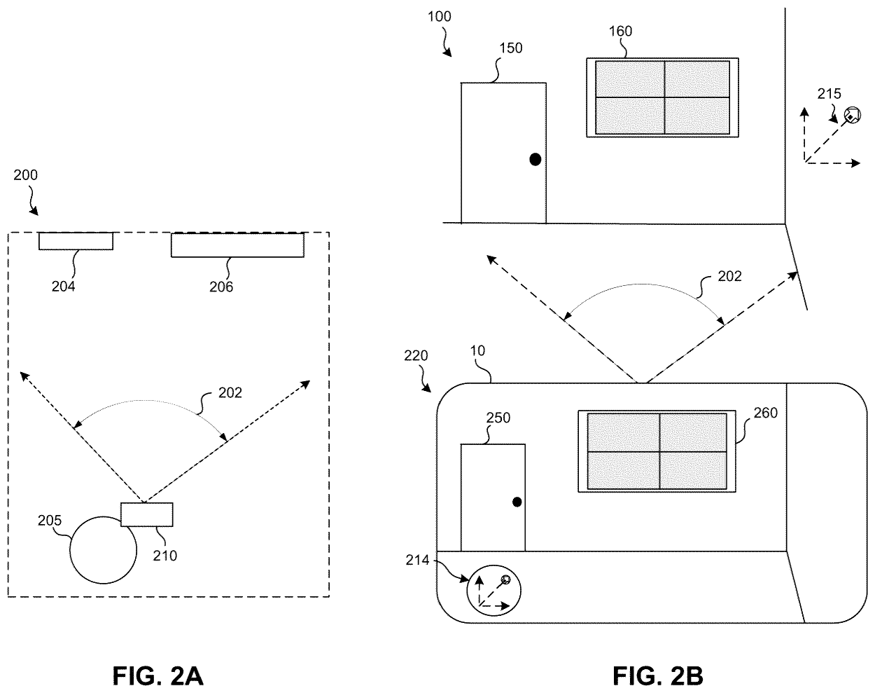

FIG. 2A illustrates an example location map 200 of a user with an electronic device in a physical environment in accordance with some implementations. A location map illustrates a two-dimensional (2D) top down view of locations of representations of users or other representations of objects within a 3D environment. For example, representation 205 and representation 210 represents user 25 holding device 10 in the physical environment 100 of FIG. 1. The location map 200 further illustrates the representation 210 (e.g., device 10) having a viewing angle 202 (e.g., a field-of-view (FOV)) of a portion of the physical environment 100, which includes representation 204 (door 150) and representation 206 (window 160). In this example, during an example of presenting content for a directional awareness session, a directional awareness instruction set executed on an electronic device (e.g., device 10), or networked through an external server, can generate a location map 200 based on the representations of the user 25, and representations of objects detected in the physical environment (e.g., representations 204, 206, and the like).

FIG. 2B illustrates an exemplary view 220 of the physical environment 100 provided by electronic device 10. The view 220 may be a live camera view of the physical environment 100, a view of the physical environment 100 through a see-through display, or a view generated based on a 3D model corresponding to the physical environment 100. The view 220 includes depictions of aspects of a physical environment 100 such as a representation 250 of door 150 and representation 260 of window 160 as included in the viewing angle 202. The electronic device 10 determines a global reference direction 215 (e.g., true north) in the physical environment 100 by using one or more known techniques, e.g., a magnetometer of the electronic device 10, and the like. In this example, the view 220 further includes a directional awareness indicator 214 (e.g., a virtual compass), that may be displayed in the view 220 based on the determined global reference direction 215 (e.g., “true north”) of the physical environment 100. For example, directional awareness indicator 214 may be provided automatically or by the user's request so they know which direction they are looking out the window. The virtual compass (e.g., a virtual icon) as the directional awareness indicator 214 is for an exemplary illustration. Additionally, or alternatively, the directional awareness indicator 214 may include spatialized audio and/or video. In an exemplary implementation, the directional awareness indicator is an audio cue played to be heard from the 3D position using spatial audio, wherein the 3D position is determined based on the identified direction. A characteristic of the spatialized audio (e.g., pitch, duration, sequence of notes, etc.) may be used to identify the type of direction being represented by the audio cue. In other implementations, other subtle visual indicators, such as a dot or arrow, may be positioned radially around the display of device 10 to indicate a reference direction (e.g., north) or a direction to a reference location.

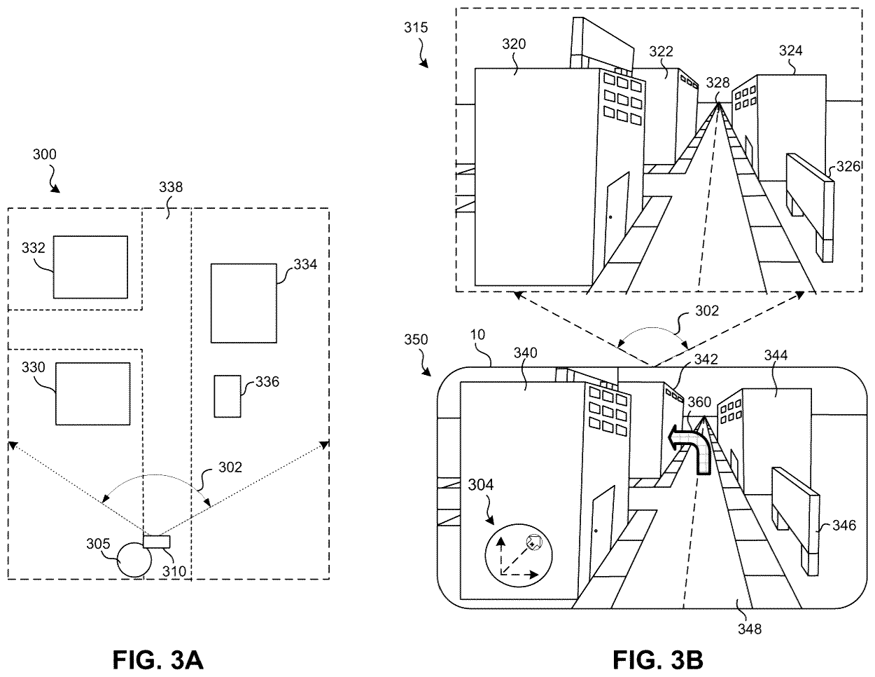

FIG. 3A illustrates an example location map 300 of a user with an electronic device in a physical environment in accordance with some implementations. A location map illustrates a 2D top down view of locations of representations of users or other representations of objects within a 3D environment. For example, representation 305 and representation 310 represents user 25 holding device 10 in physical environment 315 (e.g., on the street in a municipality). The location map 300 further illustrates the representation 310 (e.g., device 10) has a viewing angle 302 (e.g., FOV) of a portion of the physical environment 315, which includes representations 330, 332, and 334 (a first, second, and a third building) representation 336 (a sign), and representation 338 (a road), which represent the physical objects as illustrated in physical environment 315 in FIG. 3B. In this example, during an example of presenting content for a directional awareness session, a directional awareness instruction set executed on an electronic device (e.g., device 10), or networked through an external server, can generate a location map 300 based on the representations of the user 25, and representations of objects detected in the physical environment (e.g., representations 330, 332, 334, 336, 338, and the like). The location map 300 can then be used by the directional awareness instruction set to determine distance thresholds from particular objects, such as a target location. For example, the second building 322 (e.g., representation 332), may be the user's hotel that is determined to be the target location. The location map 300 can then be used to determine a distance from the device 10 to the target location to provide accurate directions via a directional awareness indicator such as a text box and/or audio cue that tells the user that the hotel is two blocks ahead and to the left.

FIG. 3B illustrates an exemplary view 350 of the physical environment 315 (e.g., a street in a municipality) provided by electronic device 10. The view 350 may be a live camera view of the physical environment 315, a view of the physical environment 315 through a see-through display, or a view generated based on a 3D model corresponding to the physical environment 315. The view 350 includes depictions of aspects of a physical environment 315 such as a representation 340 of a first building 320, representation 342 of a second building 322 (e.g., the user's hotel which may be the target location), representation 344 of a third building 324, representation 346 of a sign 326, and representation 348 of roadway 328 as included in the viewing angle 302. In some implementations, the electronic device 10 displays directional awareness indicator 360 (e.g., a visual and/or audio cue that is positioned to appear at a 3D position within the view 350) using one or more techniques described herein. Additionally, in some implementations, the electronic device 10 can determine a global reference direction (e.g., true north) in the physical environment 315 and the view 350 can include a directional awareness indicator 304 (e.g., a virtual compass), that may be displayed in the view 350 based on the determined global reference direction (e.g., “true north”) of the physical environment 315.

For example, view 350 represents a viewpoint of a user (e.g., user 25 of FIG. 1) within a physical environment 315 wearing a device (e.g., device 10 of FIG. 1), such as an HMD. A directional awareness indicator 360 is provided to the user. For example, a visual cue is presented within the viewpoint of the device 10 such that the user could be presented with an object, a message, and/or directional arrows, as illustrated, of a notification of a directional awareness. Alternatively, other methods of notifications of the directional awareness indicator 360 could be provided. In some implementations, the directional awareness indicator 360 provides an audio cue (e.g., spatialized audio) such as a “ping” to indicate to the user of the direction of the target object (e.g., “your hotel is up ahead on the left”).

In some implementations, the directional awareness indicator 360 may be spatialized in audio and/or video. In an exemplary implementation, the directional awareness indicator 360 is an audio cue played to be heard from the 3D position using spatial audio, wherein the 3D position is determined based on an identified direction of the target location (e.g., the hotel is two blocks north and on the left side of the street). Additionally, or alternatively, as illustrated in FIG. 3B, the directional awareness indicator 360 is a visual cue positioned to appear at the 3D position in a view of the physical environment provided via the electronic device, wherein the 3D position is determined based on the identified direction (e.g., via an optical see-through device).

In some implementations, the directional awareness indicator 360 is not presented based on a criterion with respect to the detected context associated with the use of the electronic device in the physical environment. For example, if the user has been to the location several times before (e.g., based on a historical comparison), then the directional awareness indicator 360 may not be presented without some additional user interaction (e.g., a user requests an indicator on where to go). Alternatively, there may be a criterion based on the movements of the user. For example, the system may be able to detect that the person is driving or in a car being driven by someone else (e.g., a taxi), and may not need an indicator either so they are not distracted (e.g., while driving), or because someone else knows where to the target location is located.

In some implementations, there is an intermittent presentation of the directional awareness indicator 360 that can be adjusted, e.g., based on convenience, in response to some feedback such as user moving toward a landmark, history/amount of times previously presented, user request to stop, and the like. In an exemplary implementation, the directional awareness indicator 360 is presented intermittently. In some implementations, presenting the directional awareness indicator intermittently is based on movement of the electronic device. In some implementations, presenting the directional awareness indicator intermittently is based on historical use of the directional awareness indicator with respect to the 3D position.

In some implementations, the directional awareness indicator 360 is modified over time based on proximity of the electronic device to the anchored location or device. For example, as the user gets closer, the spatialized audio notifications may indicate the closer proximity. Additionally, or alternatively, for a visual icon, the directional awareness indicator 360 may increase in size or start flashing if the user starts to walk in a different direction away from the target location. Additionally, instead of just an arrow, the directional awareness indicator 360 may include a text widget application that tells the user where the target location is in conjunction with the arrow (e.g., the hotel is up ahead three blocks and on your left). Additionally, or alternatively, the directional awareness indicator 360 includes a compass indicator (e.g., directional awareness indicator 304) such that an audio cue may be provided that tells the user to continue in a particular direction (e.g., “travel North on Maple street for three blocks”). Thus, a virtual compass (directional awareness indicator 304) may further guide the user in a particular direction.

In some implementations, as illustrated in FIG. 3B, the view 350 shows the directional awareness indicator 360 as “stuck” to the viewpoint of the device/user, also referred to as world-locked (e.g., locked to a 3D location in the physical environment). In some implementations, the view of the directional awareness indicator 360 may be world-locked until the user satisfies some condition such as approaching a distance threshold. After the user meets one or more distance thresholds (e.g., user is within 20 feet of the target location or at a location when they are to turn left), the directional awareness indicator 360 may change appearance. For example, in response to the user approaching and satisfying the distance threshold, the directional awareness indicator 360 may transition from being world-locked to display-locked, where the indicator 360 may appear at a particular location on the display regardless of the user's pose relative to the environment, or body-locked, where the indicator 360 may appear at a particular position and orientation offset relative to a part of the user's body, such as their torso. Other changes to the appearance, such as color, size, shape, content, or the like, may also optionally be changed upon meeting the distance threshold.

In other implementations, the directional awareness indicator 360 may be displayed as head-locked or body-locked until the user satisfies a condition, such as approaching a distance threshold. After the user meets one or more distance thresholds (e.g., user is within 20 feet of the target location or at a location when they are to turn left), the directional awareness indicator 360 may change appearance. For example, the directional awareness indicator 360 may initially be displayed in a direction, but not a distance, relative to the user that corresponds to the target location. In response to the user approaching and satisfying the distance threshold, the directional awareness indicator 360 may transition from being head-locked or body-locked to world-locked, where it is positioned at a 3D location in the physical environment (e.g., at the target location). The appearance of the directional awareness indicator 360 may also change (e.g., to display an indication stating, “This is your hotel.”). The anchoring of the directional awareness indicator 360 or other content to the target location (e.g., a real-world location) when the user satisfies a condition (e.g., a distance or visibility condition) may advantageously save power and compute resources by providing localization of content, which tends to be a resource-intensive process if localization is required to be updated as the user moves. Presenting directional awareness indicator 360 or other content at a fixed distance from the user's viewpoint may provide better visibility or legibility of content (e.g., text messages within the directional awareness indicator 360 in a manner similar to the way that holding a book at perfect distance makes it easier to read and understand).

In some implementations, a directional awareness indicator may include a haptic feedback, such as kinesthetic communication or 3D touch. Haptic feedback refers to technology that can create an experience of touch by applying forces, vibrations, or motions to the user. For example, if the user is wearing an HMD, another device such as a phone or a smart watch may vibrate and/or provide a visual message to indicate to the user a direction (e.g., similar to directional awareness indicator 360). For example, a device may playback the last heartbeat message from the user's partner on his or her watch when the partner is far away, but looking in their direction (e.g., at a crowded environment, such as an outdoor concert).

In some implementations, the directional awareness indicator 360 may be faded from the display to provide easier transitions for the user for a more enjoyable XR environment. For example, at a certain point (e.g., outside of an activation zone) as a user turns away from the directional awareness indicator 360, the directional awareness indicator 360 may fade from the display. The activation zone may be based on an anchored directional awareness indicator 360 to encourage a user to stay relatively stationary to keep the directional awareness indicator 360 within the display. As a user moves, a visual or audible indication may be presented to notify the user that the directional awareness indicator 360 is going to deactivate (e.g., fade away). Thus, a user may dismiss the directional awareness indicator 360 by turning away from the target location. In some implementations, transitioning away or fading away the directional awareness indicator 360 may be based on a rate that a user turns his or her head exceeding a threshold or an amount of turning his or her head exceeding a threshold, such that the directional awareness indicator 360 will remain in the 3D location where it was just before the user quickly turned his or her head away.

In some implementations, the system can detect the user's interaction with directional awareness indicator 360 (e.g., reaching out to “touch” the directional awareness indicator 360) and generating and displaying an application window close to the view of the user. In some implementations, the system can detect that the user has temporarily moved his or her viewing direction to another location outside of an active zone (e.g., an active zone that contains the target object (the user's hotel) within a current view). For example, the user may move their viewing direction to another location outside the active zone in response to being distracted by some event in the physical environment (e.g., another pedestrian or a car driving by across the street). Thus, the system, based on the user “looking away” from an initial active zone, starts to fade away and/or shrink the directional awareness indicator 360. However, once the user has returned to a viewpoint as the original view when the directional awareness indicator 360 and an associated application window was initially active (e.g., within an activation zone), the system can return to the display of the directional awareness indicator 360 and an associated application window as initially intended when the user activated the application by interacting with the directional awareness indicator 360, before the user was briefly distracted.

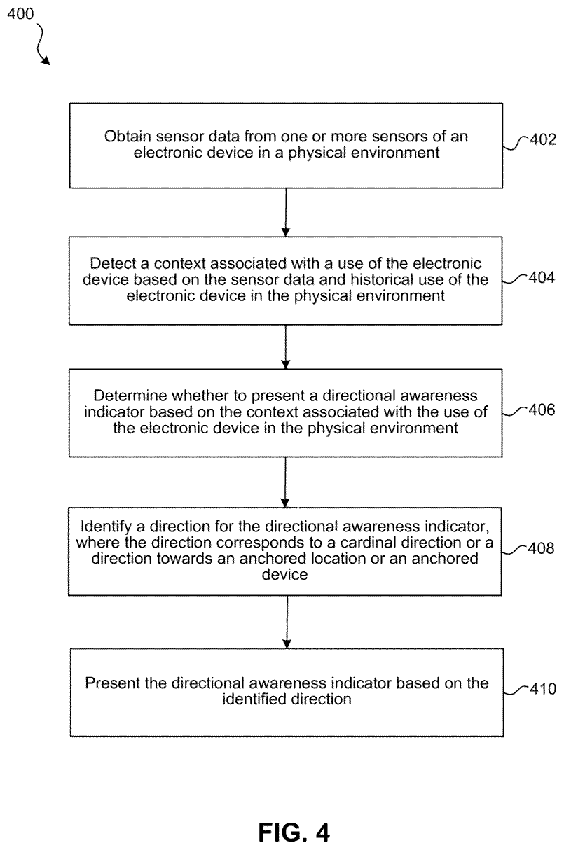

FIG. 4 is a flowchart illustrating an exemplary method 400. In some implementations, a device such as device 10 (FIG. 1) performs the techniques of method 400 of providing a directional awareness indicator (e.g., visual and/or auditory electronic content) based on context detected in a physical environment. In some implementations, the techniques of method 400 are performed on a mobile device, desktop, laptop, HMD, or server device. In some implementations, the method 400 is performed on processing logic, including hardware, firmware, software, or a combination thereof. In some implementations, the method 400 is performed on a processor executing code stored in a non-transitory computer-readable medium (e.g., a memory). Examples of method 400 are illustrated with reference to FIGS. 2-3.

At block 402, the method 400 obtains sensor data (e.g., image, sound, motion, etc.) from the sensor of the electronic device in a physical environment. For example, capturing one or more images of the user's current room, depth data, and the like. In some implementations, the sensor data includes depth data and light intensity image data obtained during an image capture process.

At block 404, the method 400 detects a context associated with a use of the electronic device based on the sensor data and historical use of the electronic device in the physical environment. For example, detecting that the user is in a situation in which the user would benefit from direction awareness assistance. Other situations may include the user has started moving towards an expected target location (e.g., a hotel location that is pulled from a calendar app). Another situation is the user has stopped moving at an intersection as if uncertain or is acting lost. Additionally, detecting a context may include determining the user is within a proximity threshold of another user's device (e.g., finding a spouse at an outdoor concert) or a particular location (e.g., a starting location of a hike).

Various ways of detecting context of a physical environment may be used by method 400. In some implementations, detecting the context includes determining use of the electronic device in a new location (e.g., walking in a city the user has not been to previously). In some implementations, detecting the context includes determining use of the electronic device during a type of activity (e.g., driving, walking, running, hiking, etc.)

At block 406, the method 400 includes determines whether to present a directional awareness indicator based on the context associated with the use of the electronic device in the physical environment. For example, a state in which the user would benefit from the directional awareness indicator (e.g., a subtle visual and/or audio, non-intrusive directional cue), may be based on a user being disoriented or lost at their current location. For example, in some implementations, detecting the context may include determining that a user of the electronic device is disoriented or lost based on head or body movements (e.g., turning around >920°, turning back and forth a threshold number of times or turning back and forth above a threshold rate, or the like), utterances (e.g., asking him/herself “where am I?”), or the like.

In some implementations, a state in which the user would benefit from the directional awareness indicator may be location based (e.g., near a particular target location or a target object). For example, in some implementations, detecting the context may include determining that the electronic device is within a proximity threshold distance of a location, an object, another electronic device, and/or a person. For example, detecting the context may include finding a spouse at an outdoor concert, notifying the user of a starting location of a hike that has many different trail options, setting a starting and/or ending point as a 3D location while going for a run at a new place, and the like.

At block 408, in accordance with determining to present the directional awareness indicator, the method 400 includes identifying a direction for a directional awareness indicator, wherein the direction corresponds to a cardinal direction (e.g., north) or a direction towards an anchored location or device.

In some implementations, identifying a direction for a directional awareness indicator associated with a region of the physical environment (e.g., a target location, such as a hotel, or another person) includes determining that the electronic device (e.g., the user wearing an HMD or holding a smart phone or a tablet) has moved within a distance threshold of the region of the physical environment. For example, a distance threshold of half a mile for a hotel, or fifty meters for locating another person (e.g., such as at an outdoor concert) may be implemented by the device, such that the directional awareness indicator would only be visible to the user if they were within the distance threshold of the target location.

In some implementations, detecting an interaction associated with the target location of the physical environment includes tracking a pose of the electronic device relative to the physical environment, and detecting, based on the pose of the electronic device, that a view of a display of the electronic device is oriented towards the target location. For example, position sensors may be utilized to acquire positioning information of the device (e.g., device 10). For the positioning information, some implementations include a visual inertial odometry (VIO) system to determine equivalent odometry information using sequential camera images (e.g., light intensity images such as RGB data) to estimate the distance traveled. Alternatively, some implementations of the present disclosure may include a SLAM system (e.g., position sensors). The SLAM system may include a multidimensional (e.g., 3D) laser scanning and range measuring system that is GPS-independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location. The SLAM system may further be a visual SLAM system that relies on light intensity image data to estimate the position and orientation of the camera and/or the device.

In some implementations, detecting an interaction associated with the target location of the physical environment includes tracking a gaze direction, and detecting that the gaze direction corresponds to the target location of the physical environment. In some implementations, tracking the gaze of a user may include tracking which pixel the user's gaze is currently focused upon. For example, obtaining physiological data (e.g., eye gaze characteristic data 40) associated with a gaze of a user may involve obtaining images of the eye or electrooculography signal (EOG) data from which gaze direction and/or movement can be determined. In some implementations, the 3D environment may be an XR environment provided while a user wears a device such as an HMD. Additionally, the XR environment may be presented to the user where virtual images may be overlaid onto the live view (e.g., augmented reality (AR)) of the physical environment. In some implementations, tracking the gaze of the user relative to the display includes tracking a pixel the user's gaze is currently focused upon.

At block 410, the method 400 presents the directional awareness indicator based on a 3D position relative to the electronic device in the identified direction. For example, the directional awareness indicator may be an audio cue played to be heard from a 3D position using spatial audio and/or a visual cue that is positioned to appear at a 3D position. The 3D position may be determined based on the identified direction, e.g., to the north of the device's position. Additionally, the directional awareness indicator may be temporary (e.g., a ping lasting for a limited time or a fading “N” that is displayed to the north). Additionally, or alternatively, the directional awareness indicator may be repeated periodically during a period, e.g., while the context persists, to provide a subtle, intuitive perception of direction.

In some implementations, the directional awareness indicator may be spatialized in audio and/or video. In an exemplary implementation, the directional awareness indicator is an audio cue played to be heard from the 3D position using spatial audio, wherein the 3D position is determined based on the identified direction. Additionally, or alternatively, as illustrated in FIG. 3B, the directional awareness indicator is a visual cue (e.g., directional awareness indicator 360) positioned to appear at the 3D position in a view of the physical environment provided via the electronic device, wherein the 3D position is determined based on the identified direction (e.g., via an optical see-through device).

In some implementations, the directional awareness indicator is not presented based on a criterion with respect to the detected context associated with the use of the electronic device in the physical environment. For example, if the user has been to the location several times before (e.g., based on a historical comparison), then the directional awareness indicator 360 may not be presented without some additional user interaction (e.g., a user's requests an indicator on where to go). Alternatively, there may be a criterion based on the movements of the user. For example, the system may be able to detect that the person is driving or in a car being driven by someone else (e.g., a taxi), and may not need an indicator either so they are not distracted (e.g., while driving), or because someone else knows where the target location is located.

In some implementations, there is an intermittent presentation of the directional awareness indicator that can be adjusted, e.g., based on convenience, in response to some feedback such as user moving toward a landmark, history/amount of times previously presented, user request to stop, and the like. In an exemplary implementation, the directional awareness indicator is presented intermittently. In some implementations, presenting the directional awareness indicator intermittently is based on movement of the electronic device. In some implementations, presenting the directional awareness indicator intermittently is based on historical use of the directional awareness indicator with respect to the 3D position. In some implementations, the method 400 further comprises, in accordance with detecting a request to stop presenting the directional awareness indicator, refraining from presenting the directional awareness indicator.

In some implementations, the directional awareness indicator is modified over time based on proximity of the electronic device to the anchored location or device. For example, as the user gets closer, the spatialized audio notifications may indicate the closer proximity. Additionally, or alternatively, for a visual icon, the directional awareness indicator may increase in size or start flashing if the user starts to walk in a different direction away from the target location. Additionally, instead of just an arrow, the directional awareness indicator may include a text widget application that tells the user where the target location is in conjunction with the arrow (e.g., the hotel is up ahead three blocks and on your left). Additionally, or alternatively, the directional awareness indicator includes a compass indicator (e.g., directional awareness indicator 214 of FIG. 2B, or directional awareness indicator 304 of FIG. 3B). Such that an audio cue may be provided that tells the user to continue in a particular direction (e.g., “travel North on Maple street for three blocks”). Thus, a virtual compass as a directional awareness indicator may guide the user in a particular direction.

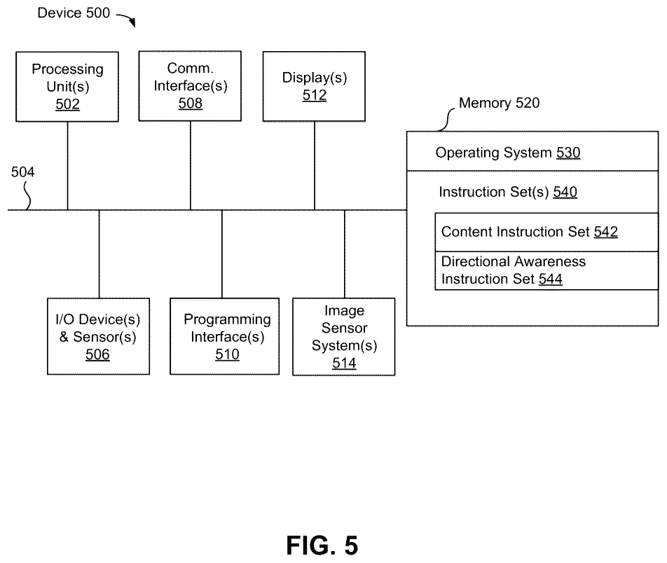

FIG. 5 is a block diagram of an example device 500. Device 500 illustrates an exemplary device configuration for device 10. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 10 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 510, one or more displays 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 512 are configured to present a view of a physical environment or a graphical environment to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 512 correspond to diffractive, reflective, polarized, holographic, etc. waveguide displays. In one example, the device 10 includes a single display. In another example, the device 10 includes a display for each eye of the user.

In some implementations, the one or more image sensor systems 514 are configured to obtain image data that corresponds to at least a portion of the physical environment 100. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 include a content instruction set 542 and a directional awareness instruction set 544. The instruction set(s) 540 may be embodied a single software executable or multiple software executables.

In some implementations, the content instruction set 542 is executable by the processing unit(s) 502 to provide and/or track content for display on a device. The content instruction set 542 may be configured to monitor and track the content over time (e.g., while viewing an XR environment), and generate and display content objects (e.g., a directional awareness indicator). To these ends, in various implementations, the instruction includes instructions and/or logic therefor, and heuristics and metadata therefor.

In some implementations, the directional awareness instruction set 544 is executable by the processing unit(s) 502 to identify a direction for a directional awareness indicator, and present the directional awareness indicator based on a 3D position relative to the electronic device in the identified direction using one or more of the techniques discussed herein or as otherwise may be appropriate. To these ends, in various implementations, the instruction includes instructions and/or logic therefor, and heuristics and metadata therefor.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

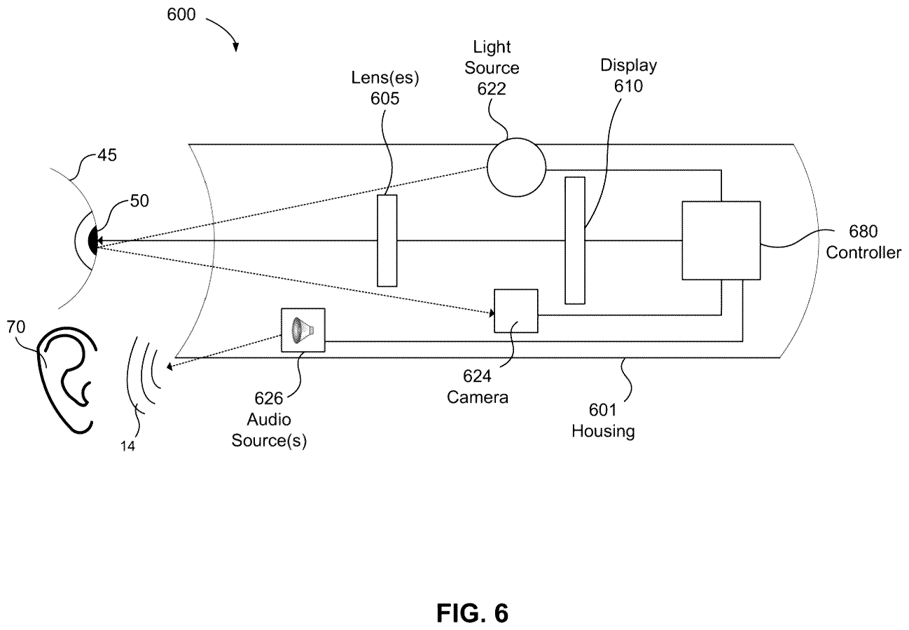

FIG. 6 illustrates a block diagram of an exemplary head-mounted device 600 in accordance with some implementations. The head-mounted device 600 includes a housing 601 (or enclosure) that houses various components of the head-mounted device 600. The housing 601 includes (or is coupled to) an eye pad (not shown) disposed at a proximal (to the user 25) end of the housing 601. In various implementations, the eye pad is a plastic or rubber piece that comfortably and snugly keeps the head-mounted device 600 in the proper position on the face of the user 25 (e.g., surrounding the eye 45 of the user 25).

The housing 601 houses a display 610 that displays an image, emitting light towards or onto the eye of a user 25. In various implementations, the display 610 emits the light through an eyepiece having one or more lenses 605 that refracts the light emitted by the display 610, making the display appear to the user 25 to be at a virtual distance farther than the actual distance from the eye to the display 610. For the user 25 to be able to focus on the display 610, in various implementations, the virtual distance is at least greater than a minimum focal distance of the eye (e.g., 7 cm). Further, in order to provide a better user experience, in various implementations, the virtual distance is greater than 1 meter.

The housing 601 also houses a tracking system including one or more light sources 622, camera 624, and a controller 680. The one or more light sources 622 emit light onto the eye of the user 25 that reflects as a light pattern (e.g., a circle of glints) that can be detected by the camera 624. Based on the light pattern, the controller 680 can determine an eye tracking characteristic of the user 25. For example, the controller 680 can determine a gaze direction and/or a blinking state (eyes open or eyes closed) of the user 25. As another example, the controller 680 can determine a pupil center, a pupil size, or a point of regard. Thus, in various implementations, the light is emitted by the one or more light sources 622, reflects off the eye 45 of the user 25, and is detected by the camera 624. In various implementations, the light from the eye 45 of the user 25 is reflected off a hot mirror or passed through an eyepiece before reaching the camera 624.

The housing 601 also houses an audio system that includes one or more audio source(s) 626 that the controller 680 can utilize for providing audio to the user's ears 70 via sound waves 14 per the techniques described herein. For example, audio source(s) 626 can provide sound for both background sound and the auditory stimulus that can be presented spatially in a 3D coordinate system. The audio source(s) 626 can include a speaker, a connection to an external speaker system such as headphones, or an external speaker connected via a wireless connection.

The display 610 emits light in a first wavelength range and the one or more light sources 622 emit light in a second wavelength range. Similarly, the camera 624 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 610 by looking at it), provide foveated rendering (e.g., present a higher resolution in an area of the display 610 the user 25 is looking at and a lower resolution elsewhere on the display 610), or correct distortions (e.g., for images to be provided on the display 610).

In various implementations, the one or more light sources 622 emit light towards the eye of the user 25 which reflects in the form of a plurality of glints.

In various implementations, the camera 624 is a frame/shutter-based camera that, at a particular point in time or multiple points in time at a frame rate, generates an image of the eye of the user 25. Each image includes a matrix of pixel values corresponding to pixels of the image which correspond to locations of a matrix of light sensors of the camera. In various implementations, each image is used to measure or track pupil dilation by measuring a change of the pixel intensities associated with one or both of a user's pupils.

In various implementations, the camera 624 is an event camera including a plurality of light sensors (e.g., a matrix of light sensors) at a plurality of respective locations that, in response to a particular light sensor detecting a change in intensity of light, generates an event message indicating a particular location of the particular light sensor.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of physiological data to improve a user's experience of an electronic device with respect to interacting with electronic content. The present disclosure contemplates that in some instances, this gathered data may include personal information data that uniquely identifies a specific person or can be used to identify interests, traits, or tendencies of a specific person. Such personal information data can include physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve interaction and control capabilities of an electronic device. Accordingly, use of such personal information data enables calculated control of the electronic device. Further, other uses for personal information data that benefit the user are also contemplated by the present disclosure.

The described technology may gather and use information from various sources. This information may, in some instances, include personal information that identifies or may be used to locate or contact a specific individual. This personal information may include demographic data, location data, telephone numbers, email addresses, date of birth, social media account names, work or home addresses, data or records associated with a user's health or fitness level, or other personal or identifying information.

The collection, storage, transfer, disclosure, analysis, or other use of personal information should comply with well-established privacy policies or practices. Privacy policies and practices that are generally recognized as meeting or exceeding industry or governmental requirements should be implemented and used. Personal information should be collected for legitimate and reasonable uses and not shared or sold outside of those uses. The collection or sharing of information should occur after receipt of the user's informed consent.

It is contemplated that, in some instances, users may selectively prevent the use of, or access to, personal information. Hardware or software features may be provided to prevent or block access to personal information. Personal information should be handled to reduce the risk of unintentional or unauthorized access or use. Risk can be reduced by limiting the collection of data and deleting the data once it is no longer needed. When applicable, data de-identification may be used to protect a user's privacy.

Although the described technology may broadly include the use of personal information, it may be implemented without accessing such personal information. In other words, the present technology may not be rendered inoperable due to the lack of some or all of such personal information.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various objects, these objects should not be limited by these terms. These terms are only used to distinguish one object from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, objects, or components, but do not preclude the presence or addition of one or more other features, integers, steps, operations, objects, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

1. A method comprising:
at an electronic device having a processor and one or more sensors:
obtaining sensor data from the one or more sensors of the electronic device in a physical environment;
detecting a context associated with a use of the electronic device based on the sensor data and historical use of the electronic device in the physical environment;
determining whether to present a directional awareness indicator based on the context associated with the use of the electronic device in the physical environment; and
in accordance with determining to present the directional awareness indicator,
identifying a direction for the directional awareness indicator, wherein the direction corresponds to a cardinal direction or a direction towards an anchored location or an anchored device, and
presenting the directional awareness indicator based on the identified direction.

2. The method of claim 1, wherein presenting the directional awareness indicator is further based on a three-dimensional (3D) position relative to the electronic device.

3. The method of claim 2, wherein the directional awareness indicator comprises an audio cue played to be heard from the 3D position using spatial audio, wherein the 3D position is determined based on the identified direction.

4. The method of claim 2, wherein the directional awareness indicator is a visual cue positioned to appear at the 3D position in a view of the physical environment provided via the electronic device, wherein the 3D position is determined based on the identified direction.

5. The method of claim 1, wherein the directional awareness indicator is not presented based on a criterion with respect to the detected context associated with the use of the electronic device in the physical environment.

6. The method of claim 1, wherein the directional awareness indicator is presented intermittently.

7. The method of claim 6, wherein presenting the directional awareness indicator intermittently is based on movement of the electronic device.

8. The method of claim 6, wherein presenting the directional awareness indicator intermittently is based on historical use of the directional awareness indicator with respect to a three-dimensional (3D) position.

9. The method of claim 1, further comprising:
in accordance with detecting a request to stop presenting the directional awareness indicator, ceasing to present the directional awareness indicator.

10. The method of claim 1, further comprising:
modifying the directional awareness indicator over time based on proximity of the electronic device to the anchored location or device.

11. The method of claim 1, wherein detecting the context comprises determining use of the electronic device in a new location.

12. The method of claim 1, wherein detecting the context comprises determining use of the electronic device during a type of activity.

13. The method of claim 1, wherein detecting the context comprises determining that a user of the electronic device is disoriented or lost.

14. The method of claim 1, wherein detecting the context comprises determining that the electronic device is within a proximity threshold distance of a location, an object, another electronic device, or a person.

15. The method of claim 1, wherein the electronic device is a head-mounted device (HMD).

16. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the device to perform operations comprising:
obtaining sensor data from one or more sensors of the device in a physical environment;
detecting a context associated with a use of the device based on the sensor data and historical use of the device in the physical environment;
determining whether to present a directional awareness indicator based on the context associated with the use of the device in the physical environment; and
in accordance with determining to present the directional awareness indicator,
identifying a direction for the directional awareness indicator, wherein the direction corresponds to a cardinal direction or a direction towards an anchored location or an anchored device, and
presenting the directional awareness indicator based on the identified direction.

17. The device of claim 16, wherein presenting the directional awareness indicator is further based on a three-dimensional (3D) position relative to the device.

18. The device of claim 17, wherein the directional awareness indicator comprises an audio cue played to be heard from the 3D position using spatial audio, wherein the 3D position is determined based on the identified direction.

19. The device of claim 17, wherein the directional awareness indicator is a visual cue positioned to appear at the 3D position in a view of the physical environment provided via the device, wherein the 3D position is determined based on the identified direction.

20-30. (canceled)

31. A non-transitory computer-readable storage medium, storing computer-executable program instructions on a computer to perform operations comprising:
obtaining sensor data from one or more sensors of an electronic device in a physical environment;
detecting a context associated with a use of the electronic device based on the sensor data and historical use of the electronic device in the physical environment;
determining whether to present a directional awareness indicator based on the context associated with the use of the electronic device in the physical environment; and
in accordance with determining to present the directional awareness indicator,
identifying a direction for the directional awareness indicator, wherein the direction corresponds to a cardinal direction or a direction towards an anchored location or an anchored device, and
presenting the directional awareness indicator based on the identified direction.

32-45. (canceled)
